(19) United States
(12) Patent Application Publication
(10) Pub. No.: US 2006/0203341 A1
(43) Pub. Date: Sep. 14, 2006

(54) Polarization-optimized illumination system

(75) Inventor: Karl-Heinz Schuster, Koenigsbronn (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/434,904

(22) Filed: May 17, 2006

Related U.S. Application Data
(63) Continuation of application No. 10/913,575, filed on Aug. 9, 2004.
Application No. 10/913,575 is a continuation of application No. PCT/EP03/01146, filed on Feb. 5, 2003.

(30) Foreign Application Priority Data
Feb. 8, 2002 (DE) 102 06 061.4

(51) Int. Cl. G02B 27/28; G02B 5/30

(52) U.S. Cl. 359/495

(57) ABSTRACT

An illumination system for a projection exposure machine, operating with ultraviolet light, for microlithography has an angle-conserving light mixing device with at least one integrator rod that has an entrance surface for receiving light from a light source, and an exit surface for outputting exit light mixed by the integrator rod. At least one prism arrangement for receiving exit light and for varying the state of polarization of the exit light is placed downstream of the integrator rod. A preferred prism arrangement has a polarization splitter surface, aligned transversely to the direction of propagation of the exit light, which passes light fractions with p-polarization without hindrance, and reflects fractions with s-polarization. The separated beams with orthogonal polarization are parallelized by means of a reflecting surface aligned parallel to the polarization splitter surface, and the same state of polarization is set for both partial beams by means of a suitable retarder.

### CROSS-REFERENCE TO RELATED APPLICATIONS

This is a continuation of application Ser. No. 10/913,575 filed on Aug. 9, 2004, which is a continuation of International Application PCT/EP03/01146, filed on Feb. 5, 2003, which was published under PCT Article 21(2) in German, the entire disclosures of which are hereby incorporated by reference.

### BACKGROUND OF THE INVENTION

1. Field of Invention

The invention relates to an illumination system for an optical device, in particular for a projection exposure machine for microlithography, and to a projection exposure machine equipped with such an illumination system.

2. Description of the Related Art

The performance of projection exposure machines for the microlithographic production of semiconductor components and other finely structured components is substantially determined by the imaging properties of the projection optics. Moreover, the image quality and the wafer throughput achievable with a machine are also determined substantially by properties of the illumination system based upstream of the projection objective. Said system must be capable of preparing the light from a light source with the highest possible efficiency and, in the process, of setting a light distribution, which can be accurately defined with reference to the position and form of illuminated regions, and in the case of which an intensity distribution that is as uniform as possible is present inside illuminated regions. These requirements are to be fulfilled equally for all settable illumination modes, for example in the case of conventional settings with different degrees of coherence, or in the case of ring field, dipole or quadrupole illumination, which are the preconditions for imaging the reticle pattern with a high interference contrast.

A requirement of increasing importance for illumination systems consists in that the latter should be capable of providing output light with a state of polarization that can be defined as precisely as possible. For example, it may be desired for the light falling onto the photomask or into the downstream projection objective to be largely or completely linearly polarized and to have a defined alignment of the preferred direction of polarization. With the aid of linearly polarized input light, it is possible, for example, for modern catadioptric projection objectives to operate with polarization beam splitters (beam splitter cube, BSC) with a theoretical efficiency of 100% at the beam splitter. It can also be desired to provide illuminating light that is largely unpolarized or very well circularly polarized in the region of the photomask. It is thereby possible, for example, to avoid differences in resolution (H−V differences, CD variations) that are dependent on structural direction and which can occur when illumination is performed with linearly polarized light and the typical structural widths of the patterns to be imaged are of the order of magnitude of the wavelength used.

Particularly with modern microlithography projection exposure machines, a further requirement consists in that a light distribution provided in the region of a pupil plane of the illumination system should be transmitted to a pupil plane on the projection objective that is conjugate to the pupil plane of the illumination system, with the distribution of the light energy being largely conserved in angular space, that is to say the transmission should be angle-conserving. Any variation in the angular spectrum that is introduced in the light path between the conjugate pupil planes leads to a distortion of the intensity distribution present in the objective pupil, and this can lead in the case of dipole or quadrupole illumination, for example, to an asymmetric irradiation in the case of the imaging two-beam interference, and thus to a worsening of the imaging performance.

A high degree of uniformity or homogeneity of the illumination falling onto the photomask (reticle) can be achieved by using a light mixing device to mix the light coming from a light source. With the light mixing devices, a distinction is made in essence between light mixing devices having honeycomb condensers and light mixing devices having integrator rods or light mixing rods. These systems have specific advantages and disadvantages. Honeycomb condensers with raster arrangements of lenses (fly's-eye lens) for generating a multiplicity of secondary light sources have the advantage that the state of polarization of the penetrating light is virtually not varied. This is opposed, as a disadvantage, by an efficiency of light transmission that is worse by comparison with integrator rods, since the passing surface has non-transmitting dead areas in the region of boundary surfaces between the individual lenses. A honeycomb condenser also varies the angular spectrum of the penetrating light on the basis of aberrations introduced by lenses.

Illumination systems that have light mixing devices with honeycomb condensers are disclosed, for example, in U.S. Pat. No. 6,211,944 B1 and U.S. Pat. No. 6,252,647 B1. An illumination system, designed for the region of visible light, for a projection apparatus for projecting the content of LCD displays is shown in U.S. Pat. No. 6,257,726 B1.

By contrast, systems with integrator rods are distinguished by a superior transmission efficiency. In the case of the illumination systems designed for ultraviolet light that are preferably considered here, an integrator rod consists of a material transparent to the light from the light source, and is transirradiated essentially along its longitudinal direction with light of a given aperture. As in a kaleidoscope, in the integrator rod the penetrating light is multiply totally reflected at the lateral boundary surfaces, it thereby being possible to achieve an approximately perfect mixing of nonhomogeneous fractions of the light. The efficacy of the mixing is a function in this case of the number of reflections in the individual directions over the rod length. In the case of the integrator rods considered here having mutually parallel, plane lateral boundary surfaces, the angular distribution of the impinging light is maintained virtually completely. A disadvantage of integrator rods is their only poorly controllable influence on the state of polarization of the penetrating light. Firstly, use is made of an optical path of great length. Because of intrinsic or induced birefringence, retardation effects of different intensity can occur on said path in the components of the electric field vector which oscillate in different directions. Secondly, there are many skew (total) reflections at the sides which, owing to their phase-shifting effect, vary the state of polarization of the penetrating light uncontrollably.

Illumination systems for the UV region that have rod-shaped light integrators are disclosed, for example, in German Patent Applications DE 44 21 053, DE 195 20 363, DE 199 12 464 or in U.S. Pat. No. 6,028,660. It is also possible for rod integrators to be designed as kaleidoscope-type waveguides with inwardly directed reflecting surfaces.

### SUMMARY OF THE INVENTION

Among the objects of the present invention are to create an illumination system that is suitable, in particular, for use in a microlithographic projection exposure machine and which transmits the light from an assigned light source with high efficiency, has a negligible influence on the angular distribution of the penetrating light, and permits a defined setting of the state of polarization of the emerging light.

These and further objects are achieved by an illumination system for an optical device, in particular for a projection exposure machine for microlithography, which has a light mixing device. The light mixing device has:

at least one integrator rod that has an entrance surface for receiving light from a light source, and an exit surface for outputting exit light mixed by the integrator rod, and

at least one prism arrangement for receiving exit light and for varying the state of polarization of the exit light, the prism arrangement having at least one polarization splitter surface aligned transverse to the direction of propagation of the exit light.

The prism arrangement has two or more prisms and effects a variation in the state of polarization of the incoming light in conjunction with complete conservation of the light energy distribution in the angular space. Here, a prism denotes a body made from a material that is transparent, that is to say transparent to the light used, and whose boundary surfaces include at least two intersecting planes. The prisms preferably have only plane boundary surfaces at which the light running in the prism is totally reflected, if appropriate repeatedly, before it emerges from the prism. Since no refraction takes place at curved surfaces, all the beam angles are conserved. The polarization splitter surface passes without hindrance the fraction of the light for which the electric field vector oscillates parallel to the plane of impingement (p-polarized light), while the light fraction for which the electric field vector oscillates perpendicular to the plane of impingement (s-polarized light) is reflected at the polarization splitter surface and thereby deflected. Here, plane of impingement designates that plane which is defined by the direction of impingement of the light and the surface normal to the polarization splitter surface. The light passed therefore has p-polarization at the exit independently of the state of polarization of the impinging light, and thus has a defined state of polarization.

The arrangement has a high transmission efficiency without further measures when the light striking the polarization splitter surface is virtually or completely p-polarized.

In order to optimize the total transmission of the light mixing device independently of the state of polarization of the light striking the polarization splitter surface, it is provided in a preferred development that the prism arrangement has at least one reflecting surface that, with reference to the polarization splitter surface, is arranged in such a way that light reflected (s-polarized) by the polarization splitter surface can be deflected with the aid of the reflecting surface into a direction of propagation that runs substantially parallel to the direction of propagation of the light passed by the polarization splitter surface. A deflection of high efficiency is possible since s-polarized light that can be reflected with high reflectance strikes the reflecting surface. It is also possible to provide a reflecting surface that, with reference to the polarization splitter surface, is arranged in such a way that the light penetrating without hindrance through the polarization splitter surface is deflected into the direction that runs substantially parallel to the direction of propagation of the light reflected by the polarization splitter surface.

In both cases, a very high fraction of the light energy irradiated on the entrance side is available downstream of the prism arrangement, the state of polarization of the two at least substantially parallel beams being defined in each case, and consequently being capable of targeted variation. The reflecting surface is preferably totally reflecting and can be formed by a boundary surface of a prism of the prism arrangement. Reflecting surfaces with normal reflection are also possible.

Preferred embodiments have an optically active polarization splitter layer at the polarization splitter surface. A polarization splitter layer is an optically active multilayer system with layers of dielectric material transparent to the optical wavelengths used, the layers lying one over another alternately consisting of high-index and low-index material. The multilayer system is aligned obliquely with reference to the impinging light substantially in such a way that angles close to the layer-specific Brewster angle determined by the refractive indices of materials occur at the boundary surfaces of the layers. It is known that the reflectance for p-polarized light is minimal for these Brewster angles, and that the corresponding transmittance is maximal.

Particularly for applications in the region of visible light, it is possible, if appropriate, to dispense with a polarization splitter layer. The prism arrangement can then operate using birefringence properties of the, for example crystalline, prism materials, and can comprise a Nicol prism, a Rochon prism or the like, for example. The polarization-selective effect can also be achieved, if appropriate, by one or more obliquely positioned plates.

Prism arrangements, in particular those having a polarization splitter layer, preferably have at least one polarization splitter block with a first and a second prism that have mutually facing boundary surfaces between which the polarization splitter surface, in particular the polarization splitter layer, is arranged. As a result, the polarization is split completely inside transparent materials, and this is advantageous for angle conservation. Otherwise, the polarization splitter block should be free, that is to say have outer surfaces suitable for total reflection in order to pass on light in an angle-conserving fashion and without light loss. Consequently, the light rod is continued on all sides in the region of the prism arrangement. The boundary surfaces of the prisms that are provided for light exit or light entrance are preferably coated at least in part with suitable antireflection layers.

In order to set a uniform state of polarization for all the light emerging from the light mixing device, use is made of suitable retardation elements or other measures with a corresponding effect. A preferred prism arrangement has at least one first exit surface for the exit of light transmitted by the polarization splitter surface, and at least one second exit surface for the exit of light reflected by the polarization splitter surface. A device for varying the state of polarization of the penetrating light, in particular at least one optical retardation element, is placed downstream of at least one of the exit surfaces. It is possible, for example, to place downstream of one of the exit surfaces a λ/2 plate or another element that effects a rotation of the preferred direction of polarization by 90°. The entire exit light is thereby uniformly p- or s-polarized. It is also possible for a λ/4 plate or another device that generates circularly polarized light from incoming linearly polarized light to be placed downstream of the two exit surfaces in each case. The entire exit surface is thereby circularly polarized, with the same sense of rotation downstream of the various exit surfaces. Further devices for varying the state of polarization can follow.

In preferred prism arrangements, the light emerges at two exit surfaces lying next to one another. In this case, a fine dividing line of diminished exit intensity can be present between the exit surfaces. In order to avoid possible effects from the imaging quality, in preferred developments for wafer scanners the polarization splitter surface is aligned in such a way that a line of section between the latter and a plane aligned perpendicular to the exit direction of the light lies transverse, in particular perpendicular, to the scanning direction. Uniform exposure is thereby possible even given the presence of a separating line.

In the case of the illumination systems considered here, light with a definite aperture is irradiated into the integrator rod, which is angle-conserving, such that the light with this aperture strikes the polarization splitter surface lying oblique to the direction of propagation. For an open bundle of light, the degree of polarization will vary asymmetrically as a rule over the aperture with reference to axially parallel beams. In order to compensate for this effect, the prism arrangement of a preferred development has a first prism group with a first polarization splitter surface, and a second prism group with a second polarization splitter surface, the polarization splitter surfaces being arranged with mirror symmetry relative to a reflecting plane of the integrator rod, which extends in the longitudinal direction of the rod and includes a line of section between the polarization splitter layers.

Light mixing devices are preferably fashioned such that the cross-sectional shape of the exit surface is adapted to the shape of the surface to be illuminated. Consequently, the rod cross section of conventional rod integrators is rectangular with an aspect ratio deviating from one. Whereas with conventional, cylindrical rod integrators the exit surface corresponds in shape and size to the entrance surface, the invention creates angle-conserving light mixing devices in the case of which the exit surface formed by the output of the prism arrangement has an exit surface cross section differing from the entrance surface cross section. In particular, the exit surface can be larger than the entrance surface. The exit surface cross section can be, for example, an integral multiple of, in particular approximately twice, the entrance surface cross section. Since the integrator rod can thereby have a smaller cross section than the desired exit surface, material may be saved by reducing the rod cross section. Moreover, the number of the reflections in one direction is enlarged, the homogeneity of the exit light in this direction thereby being improved.

Various individual measures, or measures that are advantageous in combination, can be taken in order to obtain light mixing devices of high transmission and with effective thorough mixing in conjunction with moderate requirements placed on the extent to which the polarization splitter layer can be loaded in terms of angle.

In a preferred development, it is provided that at least one integrator rod of the light mixing device consists of a UV-transparent material whose absorption edge is situated at lower wavelengths than the absorption edge of calcium fluoride. Magnesium fluoride or lithium fluoride, for example, come into consideration here as rod material. There is no problem in using birefringent material such as magnesium fluoride in the case of embodiments with a device placed downstream for changing the state of polarization, since the variation in the state of polarization that is caused by birefringence is removed downstream of the integrator rod. The use of UV-suitable materials with the lowest possible volume absorption permits rod arrangements of high useful lengths which generate sufficiently many reflections even in the case of a low internal aperture.

Alternatively, or in addition, a possibly multiple folding of an integrator rod arrangement can be provided in order to permit large overall lengths of the rod arrangement to be accommodated in a limited installation space. This can be achieved by virtue of the fact that a number of integrator rods are provided, and that at least one angle-conserving deflecting device for deflecting the light propagation direction is provided between a first integrator rod and a downstream second integrator rod. Deflections by 90 or 180° are preferred. A virtually lossless, angle-conserving deflection can be rendered possible by means of one or more interposed deflecting prisms. These deflecting prisms preferably have antireflection layers at their surfaces serving for light entrance or light exit, total reflection being maintained. The deflecting prisms are preferably made from a high-index material for whose refractive index it preferably holds that n>1.6, for example here made from BaF₂. It is thereby possible to use total reflection even in the case of large numerical apertures.

One measure for increasing the number of reflections in a rod of given length consists in dividing the integrator rod into an undivided rod section directly in front of the exit surface and at least one divided rod section that is placed upstream of the undivided rod section and has at least two totally reflecting rodlets that essentially fill up the entire cross section of the integrator rod. Higher reflectivities, and thereby more thorough mixing are achieved here owing to the smaller rod cross sections in the region of the rodlets, the downstream undivided section effecting a further homogenization. It is likewise possible to have a stepped division over the length of the rod, it being possible, for example, to provide two or more divided regions with different numbers of rodlets.

Additional degrees of freedom in the optimization of the light mixing device with regard to material and polarization-optical effect have been achieved in the case of preferred developments by virtue of the fact that the integrator rod consists of a first material, and at least one prism of the prism arrangement and/or at least one deflecting prism consists of a second material that differs from the first material. It is to be taken into consideration in this case that the prisms arranged in front of and/or behind an integrator rod are relatively small by comparison with the integrator rod, and so an intrinsic birefringence that is possibly present is of little significance. For example, in the case of a system for a wavelength of 157 nm, the prisms can consist of calcium fluoride, barium fluoride—which is available cost effectively only in small volumes, synthetic silica glass or another suitable, optically isotropic material. The rod material should be selected with regard to low absorption; calcium fluoride, magnesium fluoride or lithium fluoride, for example, can be used.

A targeted selection of material can also be used for the purpose of optimizing the polarization-splitting effect of a polarization-splitter block with a polarization splitter layer system. For this purpose, the material of the first and of the second prism is selected as a function of the refractive index ratios in the polarization splitter layer such that an angular offset between the impingement direction of the light falling on the polarization splitter layer and a direction corresponding to the Brewster angle of the layer system is optimized, in particular minimized. It is thereby possible to achieve a maximum transmittance for p-polarized light. Materials with a high refractive index, in particular n>1.6, for example BaF₂, are preferred as prism material. Total reflection can thereby be used even given a high NA.

It is provided in accordance with one development that at least some, preferably all the totally reflecting and non-totally reflecting surfaces are coated with a reflecting effect by a thin coating with a phase-conserving effect. Two types of phase-conserving layer systems are particularly advantageous, depending on surface type. On the lateral surfaces, which do not serve as light entrance or light exit surfaces, the layers are preferably optimized for phase conservation in reflection and/or total reflection. The layers preferably have a double function for those surfaces that serve as light entrance or light exit surfaces. They act in reflection, in particular in the case of total reflection, in a fashion correcting and/or conserving phase, and in transmission as antireflection layers. Layers of this type can be provided, in particular, for all perpendicular surfaces of the prisms of the prism arrangement.

In one development, the light mixing device is assigned at least one diaphragm for setting the spatial distribution of the energy of an illumination field generated by the light mixing device, the diaphragm preferably having movable diaphragm elements for the controlled variation of the width of an illumination field as a function of positions along the length of the illumination field. It is possible thereby, for example, for the width of the illumination field to be reduced to such an extent at a longitudinal position in which an increased light intensity prevails that substantially the same illumination dosage is achieved by the integrating action of a scanning movement over the entire length of the illumination field. An example of such a diaphragm is disclosed in U.S. Pat. No. 6,097,474, whose disclosure content is to this extent incorporated in this description by reference.

The illumination system can be designed such that light emerging from the light mixing device falls without interposed imaging onto the structure to be illuminated, for example a photomask. One advantage in this case is the substantially reduced NA in the beam splitter of the projection objective, and thus in the polarization splitter layer thereof. In preferred developments, an objective is placed downstream that images the region of the light exit of the light mixing device onto the reticle that is arranged in the object plane of the downstream projection objective. This objective has at least one plane that is a Fourier-transformed plane relative to the reticle plane and consequently lies at a conjugate point relative to the pupil of the downstream projection objective. In one preferred embodiment, there is provided in the region of the pupil of this objective a polarization filter that acts as a polarization-selective retroreflector of the type of a cat's eye (in one section), and has a number of pairs of polarization splitter surfaces or polarization splitter layers arranged in a V-shaped fashion at an angle to one another. In the said installation position, the polarization filter acts as an intermediate polarizer in order to refresh the state of polarization of the incoming light, or to correct it such that only p-polarized light is passed and s-polarized light is reflected.

Filters of this type are also useful independently of other features of the invention.

The invention is further directed to structures and devises associated with the illumination system, and to associated processes. For instance, the invention also encompasses a method for producing finely structured components, such as semiconductor components, that includes:

providing a mask with a prescribed pattern;

illuminating the mask with ultraviolet light of a given wavelength using an illumination system of the type described above; and

projecting an image of the pattern onto a photosensitive substrate arranged in the region of the image plane of a projection objective.

The invention also encompasses, inter alia, a polarization filter and a projection exposure system.

Additional advantageous developments are described herein, including, but not limited to, recitations in the dependent claims. The wording of all the claims is incorporated in this description by reference. Apart from following from the claims, the present and further features and aspects of the invention also follow from the description and the drawings, the individual features being implemented respectively on their own or separately in the form of subcombinations in an embodiment of the invention or in other areas, and can constitute designs that are advantageous and capable of protection per se.

### BRIEF DESCRIPTION OF THE DRAWINGS

FIG. 1 shows a schematic of a projection exposure machine for microlithography having an embodiment of an illumination device according to the invention;

FIG. 2 shows an axial plan view of the light exit side of a light mixing device of the type shown in FIG. 1;

FIG. 3 shows a schematic section through the exit-side end region of an embodiment of a light mixing device according to the invention with a preferred variant of a prism arrangement;

FIG. 4 shows a schematic section through the exit-side end region of another embodiment of a light mixing device;

FIG. 5 shows a schematic section through the exit-side end region of a further, different embodiment of a light mixing device;

FIG. 6 shows a diagram of an embodiment of a light mixing device with four integrator rods and multiple folding of the integrator rod arrangement;

FIG. 7 shows another embodiment of a light mixing device having two integrator rods, offset in parallel, and beam deflection by 180°;

FIG. 8 shows a perspective view of an integrator rod having two divided rod sections and one undivided rod section;

FIG. 9 shows a schematic section through the exit-side end region of an embodiment of a light mixing device with a prism arrangement of mirror-symmetric design;

FIG. 10 shows schematic illustrations of the degree of polarization for p-polarization, as a function of the beam aperture for asymmetric output (a) and for symmetrical output (b) of the light mixing device;

FIG. 11 shows a schematic illustration of a preferred embodiment of a microlithographic projection exposure machine; and

FIG. 12 shows an embodiment of a polarization filter that has a prism arrangement with a number of prisms between which there are arranged polarization beam splitter layers arranged in the form of a zig-zag.

### DETAILED DESCRIPTION OF THE PREFERRED EMBODIMENTS

An example of a projection exposure machine 1 for the microlithographic production of integrated circuits and other finely structured components in conjunction with resolutions down to fractions of 1 μm is provided in FIG. 1. The machine 1 comprises an illumination system 2 for illuminating a photomask 5 arranged in the image plane 4 of the illumination system, and a projection objective 6 that images the pattern, arranged in its object plane 4, of the photomask into the image plane 7 of the projection objective on a reducing scale. A semiconductor wafer coated with a photosensitive layer, for example, is located in the image plane 7.

Serving as light source of the illumination system 2 is a laser 8, for example an excimer laser customary in the deep ultraviolet (DUV) region and having an operating wavelength of 248 nm, 193 nm or 157 nm. The light of the output light beam is largely linearly polarized. A downstream optical device 9 shapes the light from the light source and transmits it into a downstream light mixing device 10. In the example shown, the optical device 9 comprises a beam expander downstream of the laser 8 which serves the purpose of coherence reduction and beam shaping to a rectangular beam cross section with an aspect ratio x/y of its side lengths of more than one. A first diffractive optical raster element downstream of the beam expander is seated in the object plane of a downstream zoom objective in whose exit pupil a second optical raster element is provided. From the latter, the light enters an incoupling optical system that transmits the light into the light mixing device. The light is mixed and homogenized inside the light mixing device 10 by repeated internal reflection, and emerges at the exit 11 of the light mixing device in a largely homogenized fashion. Directly at the exit of the light mixing device is an intermediate field plane in which a reticle masking system (REMA) 12, an adjustable field diaphragm, is arranged. The downstream objective 13, which is also denoted as REMA objective, has a number of lens groups, a pupil plane 14 and a deflecting mirror 15, and images the intermediate field plane of the reticle masking system onto the reticle or the photomask 5.

Further details on the design and mode of operation of such an illumination system may be gathered from DE 195 20 563, whose content is to this extent incorporated in this application by reference. An important difference from the illumination system of DE 195 20 563 consists in the design of the light mixing device 10, which will be described further in detail.

In the case of a wafer stepper on the reticle 5 the entire structured surface corresponding to a chip, generally a rectangle with an arbitrary aspect ratio between height and width of, for example, 1:1 to 1:2, is illuminated as uniformly and in as sharply edged a fashion as possible. In the case of a wafer scanner of the type illustrated, a narrow strip, for example a rectangle with an aspect ratio of typically 1:2 to 1:8, is illuminated on the reticle 5, and the entire structured field of a chip is serially illuminated by scanning in a direction corresponding to the y-direction of the illumination system. Here, as well, the illumination is to be fashioned extremely uniformly and, at least in the direction perpendicular to the scanning direction, that is to say in the x-direction, in a sharply edged way.

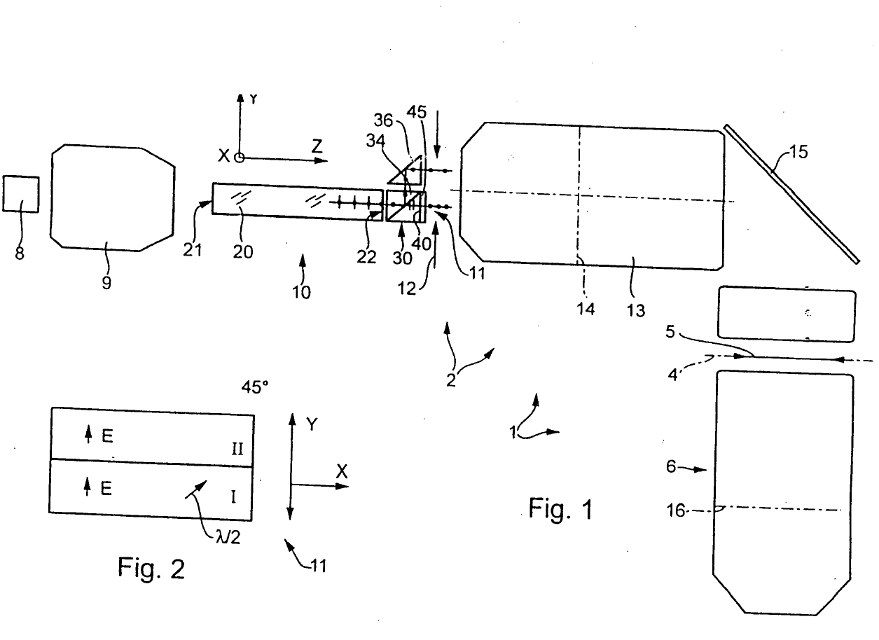

In exceptional cases, other forms of the illuminated surface are also possible on the photomask 5. The opening of the reticle masking system 12, and the cross-sectional shape of the light exit 11 of the light mixing device 10 are precisely adapted to the required field shape. The axial plan view, shown in FIG. 2, of the exit side 11 of the light mixing device 10 shows schematically that the width in the x-direction is a multiple of the overall height in the y-direction (scanning direction).

The light mixing device 10 comprises an integrator rod 20 and a prism arrangement 30 directly downstream at a small air spacing. The integrator rod is a rod of rectangular cross section made from a material transparent to the light from the light source 8, for example from crystalline calcium fluoride. The longitudinal axis of the rod runs parallel to the z-direction or to the optical axis of the illumination system. The rod 20 has a flat entrance surface 21 facing the optical device 9 for the purpose of receiving a shaped light beam from the light source 8, a flat exit surface 22, from which light that is mixed inside the integrator rod 20 emerges, and flat lateral surfaces running in pairs parallel to one another.

The prism arrangement 30 has a module with three prisms 31, 32 and 33 that are identically shaped and dimensioned in the case of preferred embodiments. They are preferably in each case prisms with two mutually perpendicular boundary surfaces of essentially the same size (perpendicular surfaces) and a larger hypotenuse surface that is aligned at an angle of approximately 45° to the perpendicular surfaces. Two of the prisms, specifically the first prism 31 and the second prism 32, enclose a plane polarization splitter layer 34 between their hypotenuse surfaces and form a compact, cuboid polarization splitter block 35 with an approximately square cross section in the y-z plane and perpendicular surfaces whose cross section corresponds to the cross section of the rod exit surface 22. The hypotenuse of the third prism 33, which is also denoted here as a reflecting prism, is aligned parallel to the polarization splitter surface 34 and forms a plane, reflecting, preferably totally reflecting surface 36.

The mutually facing perpendicular surfaces of the polarization splitter block 35 and third prism 33 have a slight spacing 37 from one another that can be of the order of magnitude of a few light wavelengths of the light used in order to permit total reflection at the adjacent perpendicular surfaces. The other free prism surfaces also border on gas or another optically thinner medium, in order to permit total reflection. In particular, there is also a slight air spacing 39 between the exit surface 22 of the integrator rod 20 and the entrance surface 38 of the beam splitter block. The prisms 31 to 33 of the prism arrangement can be fixed in a common mount which can, in turn, be fastened on a mount for the integrator rod 20, in order to fix the geometry of the arrangement.

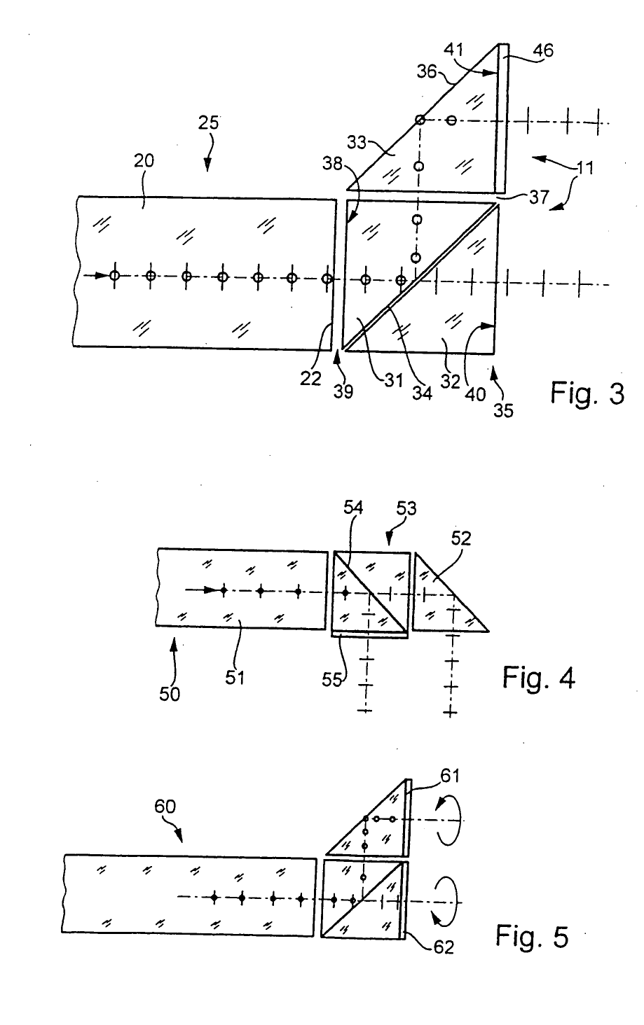

The light mixing devices of FIGS. 1 and 3 are of identical design with reference to the integrator rod and prism arrangement, for which reason the same reference numerals are used for corresponding features.

In the light mixing device 10 in FIG. 1, there is wrung on to the exit-side perpendicular surface 40 of the third prism 32 a retardation element 45 that is designed as a λ/2 plate and is a rectangular plate made from birefringent material whose axial thickness and crystal axis are dimensioned so as to produce a retardation of half a wavelength between the components of the electric field vector, which oscillate perpendicular to one another, and this causes an existing preferred direction of polarization to rotate by 90° about the direction of propagation of the light.

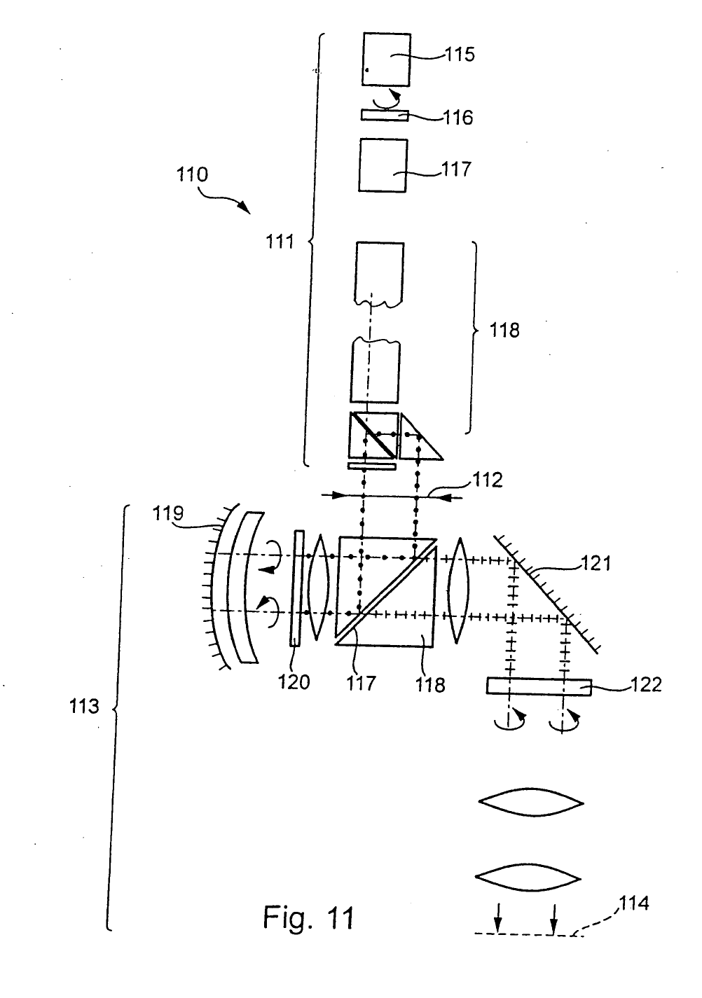

The projection exposure machine shown here operates with largely linearly polarized input light from the laser. In the example, the projection objective 6 is a catadioptic projection objective with a polarization-selective, physical beam splitter (an example will be explained further in conjunction with FIG. 11). Such projection objectives operate in the region of the beam splitter at highest efficiency when suitably linearly polarized light is irradiated. This gives rise to the requirement that the illumination system between the laser 8 and light exit should conserve polarization and/or should permit a targeted setting of the state of polarization of the impinging light. In addition, there is the requirement of achieving an angle-conserving mixing of light in order for a spatial intensity distribution generated in the region of a pupil plane of the optical device 9 to be reproduced in the pupil plane 16 of the projection objective that is optically conjugate to said pupil plane.

The light mixing device 10 meets this requirement for an angle-conserving mixing of light because of the exclusively plane, reflecting, preferably totally reflecting boundary surfaces at the integrator rod and prism arrangement. Moreover, it is rendered possible to set a defined state of polarization at the exit 11 of the light mixing device. Because of permanent or induced or intrinsic birefringence of the rod material, and of a multiplicity of skew reflections at the lateral surfaces, substantial phase shifts between the various field components of the light can occur in the integrator rod 20. Consequently, there is normally a variation in the degree of polarization of the input light that is difficult to control, and partially polarized light emerges at the rod exit 22. Said light emerges from the exit surface 22, which is provided with an antireflection layer, and, via the antireflection-coated entrance surface 38, enters the beam splitter block 35 in which the polarization splitter layer 34 is located at an angle of approximately 45° to the irradiation direction. This passes without hindrance all the light that oscillates in the plane of incidence (p-polarization, marked by dashes perpendicular to the direction of propagation). All the light that oscillates perpendicular to the plane of incidence (s-polarization, marked by points along the direction of propagation) is reflected at an angle of incidence of approximately 45° to the polarization splitter layer, and leaves the polarization splitter block essentially perpendicular to the direction of irradiation via an antireflection-coated perpendicular surface in the direction of the third prism 33. The reflected light emerging substantially perpendicular to the longitudinal axis of the rod is deflected at the reflecting surface 36 of the third prism by approximately 90° such that its direction of propagation downstream of the reflecting surface 36 runs substantially parallel to the direction of propagation of the light passed by the polarization splitter layer 34.

In the embodiment in accordance with FIG. 1, the p-polarized light transmitted through the layer 34 is converted without loss into s-polarized light by the λ/2 plate 45, and so both exit rays are s-polarized. An s-polarization at the input of the REMA objective 13 is advantageous in the case of those embodiments that, like the embodiment in accordance with FIG. 1, have inside the objective a deflecting mirror 15 that has a higher reflectance for s-polarization than for p-polarization.

In the case of the embodiment of a light mixing device 25 in accordance with FIG. 3, by contrast, the preferred direction of polarization of the s-polarized radiation downstream of the reflecting surface is rotated by 90° by the retardation plate 46 that is wrung onto the exit 41 of the reflecting prism 33. The two outputs lying one above another (compare FIG. 2) now have identical p-polarization.

In both cases, identically polarized parallel exit beams are produced that have over their surface as a whole the cross section desired for the light exit side 11 of the light mixing device, for example 12×22 mm. This cross section is twice as large as the cross section of the rod entrance surface 21. The result is thus simultaneously to create an angle-conserving light mixing device with a light exit that can be defined accurately with reference to the state of polarization and for which the cross section of the exit surface 11 deviates from the cross section of the entrance surface 21. In addition to the factor of two shown, other surface ratios are also possible, in particular integral multiples of the entrance surface cross section.

It is now possible to scan in the y-direction (FIG. 2) with the aid of this cross section. Reticle masking can also be carried out using a REMA objective 13 that effectively conserves polarization. The fine separation resulting from the air gap 37 between the fields I and II lying one above another is rendered insignificant for imaging by the scanning. Another striking feature of the functioning is that a longer distance with light mixing is covered in the top lying field II leading through the third prism. This is also insignificant for uniform illumination. Each individual light mixing path completely maintains its function in optical terms, since all exposed prism surfaces are totally reflecting at the perpendicular surfaces. These perpendicular surfaces are coated with a phase-conserving coating.

The light mixing devices 10 and 25 shown are useful not only in the case of largely linearly polarized input light, but deliver completely polarized light with s- or p-polarization at the exit 11 independently of the degree of polarization of the input light. This may be seen from the fact that p-polarization is transmitted and s-polarization is reflected to the mirror 36 independently of the input polarization (for example unpolarized, circularly polarized, linearly polarized or with rotating linear polarization) at the beam splitter surface 34.

The embodiment in accordance with FIG. 4 is distinguished by contrast with the above embodiments in that the exit light of the light mixing device 50 is output substantially perpendicular to the longitudinal axis of the integrator rod 51. The reflecting prism 52 is arranged downstream of the beam splitter block 53 in an extension of the integrator rod 51 such that light with p-polarization that passes unhindered through the beam splitter surface 54 is diverted downward by 90°. The s-component of the light entering the beam splitter block is deflected downward at a right angle at the splitter surface 54, and converted without loss into light with p-polarization by a downstream λ/2 plate 55. It may easily be seen that the arrangement can be switched over for outputting s-polarized light by removing the retardation plate 55 from the output of the polarization splitter block 53 and fitting it downstream of the output of the reflecting prism 52.

The possibility demonstrated here for the case of an angle-conserving light mixing device with an integrator rod of optionally arranging the light exit direction in an extension of the rod, or perpendicular thereto, increases the degrees of freedom in the design of illumination systems equipped with light mixing devices according to the invention.

With reference to the integrator rod 20 and prism arrangement 30, the embodiment of a light mixing device 60 in FIG. 5 is fashioned identically to the embodiment in accordance with FIGS. 1 and 2. By contrast with the latter embodiment, a λ/4 retardation plate 61, 62 is wrung in each case onto the exit surfaces of the beam splitter block 35 and reflecting prism 33. As a result, the linearly polarized light with s- or p-polarization emerging from the prism arrangement is respectively converted into light of circular polarization, specifically with the same sense of rotation of the two beams.

Circularly polarized light whose properties are similar to those of unpolarized light can be radiated directly onto a reticle, if appropriate without the interposition of a REMA objective, and prevents the production of so-called H−V differences at the reticle that can occur when, given the use of linearly polarized light, the typical structural widths at the reticle are of the order of magnitude of the light wavelength used. When use is made of a projection objective with a polarization beam splitter, before entrance into the beam splitter block the light would then need to be converted into linearly polarized light of suitable alignment by a further λ/4 plate or the like. It is preferred for a λ/4 plate upstream of the reticle and a λ/4 plate downstream of the reticle to be exactly perpendicular to one another. As a result, the incomplete λ/4 effect for a very large aperture can be completely compensated by the downstream λ/4 plate.

Circularly polarized light is also advantageously useful in conjunction with unipartite REMA objectives without an internal mirror.

In the case of prism arrangements with a polarization splitter layer, the possibly high aperture in the integrator rod places particularly high demands on the extent to which the polarization splitter layer can be loaded in terms of angle. This should provide its polarization-selective action over as large as possible a range of angles about a direction of irradiation. In addition, problems arise with the layer materials in the case of systems for the shortest operating wavelengths, for example 193 nm or 157 nm. Whereas in the case of a few suitable layer materials the absorption edge is still sufficiently far removed for 193 nm that the materials do not absorb or do so only slightly, at 157 nm the selection of suitable layer materials is reduced essentially to magnesium fluoride and representatives as low-index layer material, and to lanthanum fluoride, barium fluoride and comparable materials as high-index layer material. The largest angular bandwidth can be achieved by as large as possible a difference in refractive index between the layer materials. Since only slight differences in refractive index can be achieved because of the limited material selection, particularly at 157 nm, increasing the number of the high-index/low-index pairs of layers is essentially the only measure remaining for the polarization splitter layer. This is attended by problems in production and service life; in addition, it is thereby impossible arbitrarily to increase the loadability in terms of angle.

These problems can be alleviated by lowering the internal aperture of the integrator rod, something which leads to a reduction in the angular loading of the polarization splitter layer. An enlargement of the cross section of an integrator rod associated therewith would diminish the number of reflections in the case of no change to the overall length of a rod, as a result of which the mixing and the uniformity of the illumination at the reticle would suffer. Compensation by larger overall lengths can lead to design difficulties in the surroundings of the installation; moreover, transmission losses result through absorption over the longer path in the rod material, customarily calcium fluoride or silica glass.

In order in the case of a reduced aperture of the rod to obtain adequate transmission efficiency and good mixing, individual ones or a number of the measures described below can be used alternatively or cumulatively. One measure consists in replacing the calcium fluoride customarily used as rod material by magnesium fluoride, something which improves the transmission, since magnesium fluoride has a substantially higher spacing from the absorption edge. A birefringence thereby introduced in the rod material is not a problem, since a desired state of polarization can be reproduced without loss in any case by the downstream prism arrangement. Furthermore, it is possible, while retaining the customary overall length, if appropriate, to provide between the rod entrance and exit surface of the light mixing device a rod arrangement with at least two integrator rods between which at least one angle-conserving deflecting device is provided. Single or multiple folds of the light path inside the light mixing device are possible in this way. In the case of two folds, a three-dimensional fold is also conceivable in addition to a two-dimensional fold.

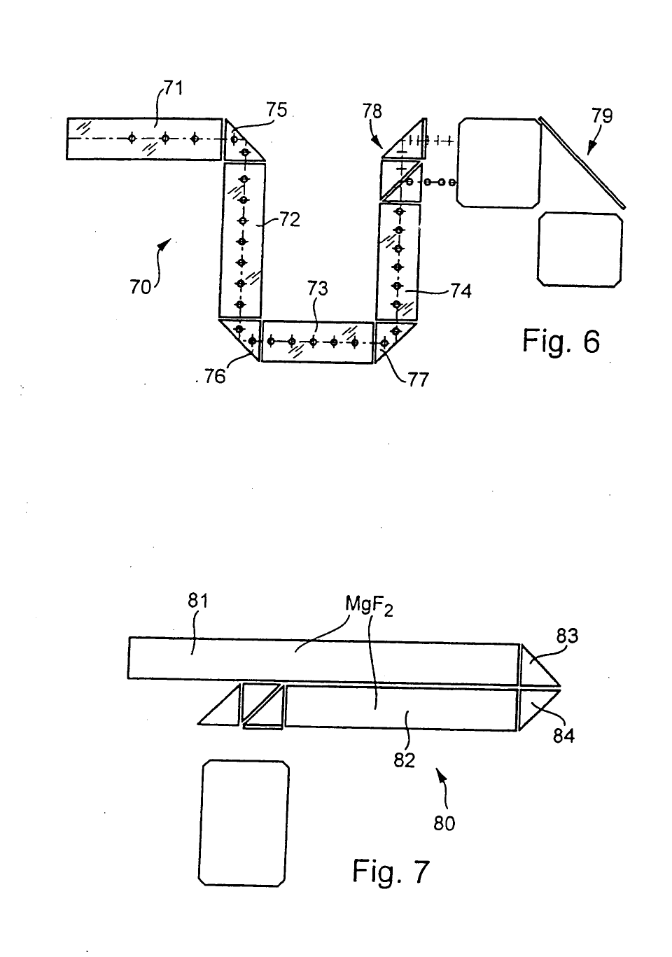

The embodiment in FIG. 6 has a light mixing device 70 with four integrator rods 71, 72, 73, 74 between which angle-conserving deflecting devices in the form of isosceles 90° deflecting prisms 75, 76, 77 are provided in each case for deflecting the light propagation direction by 90° in each case. The light entrance and exit surfaces border on gas in each case. Shown downstream of the exit of the last integrator rod 74 is a prism arrangement 78 similar to the arrangement in accordance with FIG. 4, which aligns the direction of exit of the two identically polarized beams perpendicular to the longitudinal axis of the last integrator rod 74 and parallel to the direction of irradiation at the entrance of the first rod 71. A divided REMA objective 79 with a deflecting mirror is located downstream of the light mixing device, which is designed to output s-polarized light. The axial installation space (spacing between the entrance surface of the first integrator rod 71 and light exit at the prism arrangement) is only half as large in this embodiment as the overall light path that results essentially from the overall length of the integrator rods and the transirradiated lengths of the deflecting prisms and of the prism arrangement.

The embodiment of a light mixing device 80 in FIG. 7 shows by way of example that a parallel arrangement of two (or more) integrator rods 81, 82 render it possible to have in the small installation space a large light path that can be a multiple of the direct distance between the entrance in the integrator rod and exit at the prism arrangement. A 180° deflection between the integrator rods is achieved by means of two identically dimensioned, totally reflecting deflecting prisms 83, 84, arranged in mirror-image fashion between the exit of the first rod 81 and entrance of the second rod 82. An adequate small air spacing exists in each case between the integrator rods and between these and the assigned deflecting prisms, in order to permit total reflection inside the optical components, which are bounded by straight surfaces.

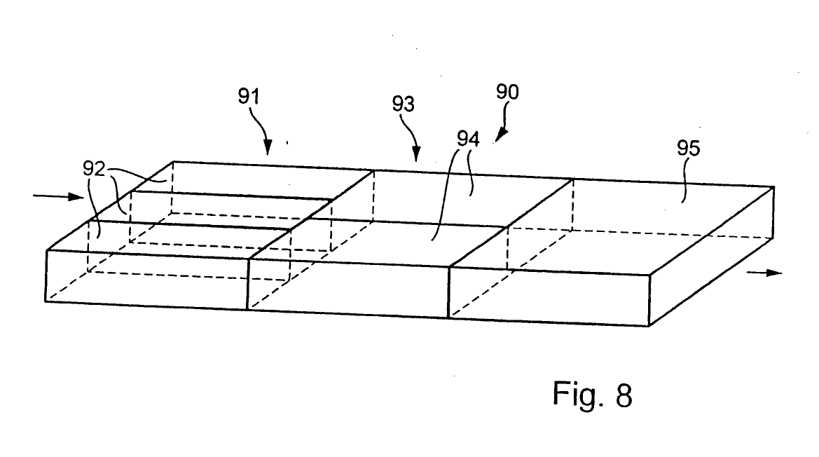

Another measure, which can be applied as an alternative or in addition to the measures described consists, if appropriate, in leaving the length of one integrator rod, lowering the internal aperture by increasing the cross section, and providing on the rod at least one divided rod section that has two or more totally reflecting rodlets whose overall cross section corresponds substantially to the original rod cross section. The number of reflections is increased overall by the reduction in cross section of the rodlets of the divided rod cross section, and so that exit-side uniformity can be improved. An example of such an integrator rod 90 is shown in FIG. 8. It has an entrance-side first rod section 91 with three identically dimensioned rodlets 92, a second divided rod section 93 that follows on and has only two identical rodlets 94 on the same cross section, as well as an undivided rod section 95 on the exit side whose length is then dimensioned so as to ensure adequate mixing overall. Instead of the doubly stepped division shown by way of example, it is also possible to provide only a divided section and an undivided rod section or more than two divided sections that precede an undivided rod section. It is also necessary here to ensure that those boundary surfaces of the rodlets which are opposite one another laterally have a slight spacing from one another such that they can act in a totally reflecting fashion.

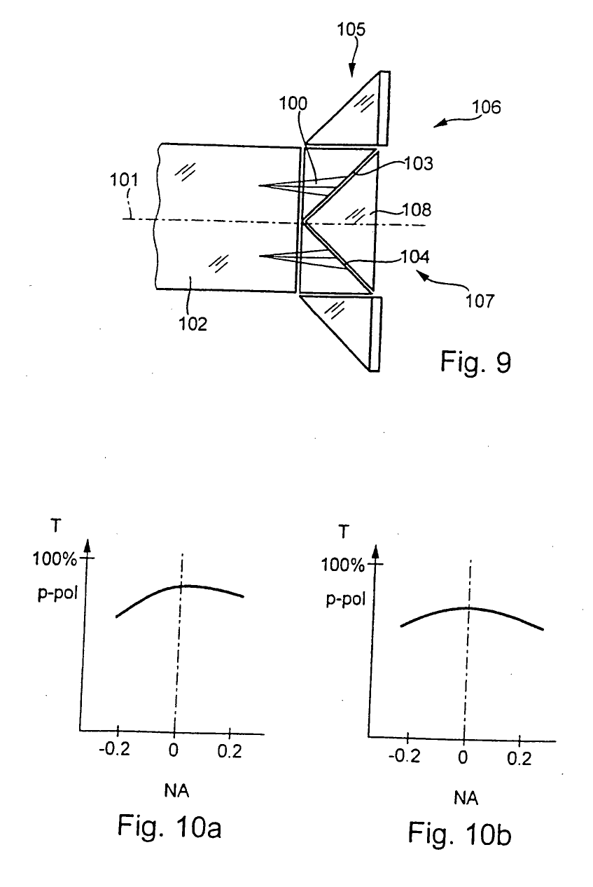

In the case of the use of a polarization splitter layer that is aligned obliquely to the direction of propagation of an open light bundle, the degree of polarization of the penetrating radiation will vary over the angle of aperture or the aperture of the beams, specifically asymmetrically relative to the direction corresponding to the direction of propagation (corresponding aperture NA=0). This is illustrated with the aid of FIG. 9, where it is shown that the edge beams of the beam bundle strike the polarization splitter layer 103 at different angles of incidence given an open beam bundle 100 that propagates parallel to the longitudinal axis 101 of an integrator rod 102. In this case, the angle of incidence (angle between the direction of incidence and the surface normal to the polarization splitter layer) varies symmetrically about the angle of incidence of the direction of incidence (normally approximately 45°). However, since the transmittance of a polarization splitter layer normally does not vary symmetrically about the mean angle of incidence (typically in the region of 45°, close to the Brewster angle), an asymmetric transmission T for p-polarized light results overall for the beams of the bundle with reference to the direction of irradiation (NA=0). This situation is shown schematically in FIG. 10 (a).

The asymmetric polarization for the open bundle is compensated by a mirror-symmetric design of the polarization splitter layers with reference to this reflecting plane, which runs in the longitudinal direction of the rod and contains a line of section between the polarization splitter surfaces. At the exit, this arrangement results in a distribution of the overall transmittance for p-polarization that is symmetrical in relation to the direction of irradiation (FIG. 10 (b)). This is achieved in the example shown by means of a prism arrangement 105 that has a first prism group 106 and a second prism group 107, the two prism groups being arranged with mirror symmetry relative to the said reflecting plane of the integrator rod 102. Each prism group is essentially of identical design to the prism arrangement 30 in FIG. 3, the second prisms 32 situated with mirror symmetry relative to one another being integrated to form a single prism 108 downstream of the polarization splitter layers 103, 104 aligned at a right angle to one another. This prism arrangement has two polarization splitter surfaces 103, 104 that are aligned with mirror symmetry relative to the reflecting surface of the integrator rod and in each case at approximately 45° to the longitudinal axis of the rod, and whose asymmetric effects on the incident radiation compensate one another.

This value of the degree of polarization can be set uniformly over the pupil by means of an appropriate apodization filter in the REMA objective. However, apodization is generally neither necessary nor expedient. For the interference contrast that is to be maximized for the ring field and dipole types of illumination that are prominent here, the balancing of the partial intensities of mutually interfering beams is already achieved by the proposed symmetrical design. Since an apodization filter generally destroys light, it can be omitted thanks to the symmetrical prism arrangement. In the event of enlarged rod geometry, the symmetrical design of a prism arrangement in accordance with FIG. 9 once again reduces the prisms by a factor of 2. This can be advantageous, since although the individual prisms ought to be used as best as possible with reference to crystal orientation, it is possible, particularly at 157 nm, for there to remain an aperture-induced contribution to the intrinsic birefringence that cannot be compensated for. This is no problem at larger wavelengths, for example 193 nm, since it is possible here to use prisms made from synthetic silica glass without intrinsic birefringence. Consequently, as in the case of all other embodiments, it is possible here to combine different suitable materials for the integrator rod and the prisms of prism arrangements and deflecting devices.

A possible overall design of the optical components of a projection exposure machine 110 will be shown by way of example with the aid of FIG. 11; said machine comprising an illumination system 111 for illuminating a photomask 112, and a projection objective 113 for imaging the photomask onto a wafer arranged in the image plane 114 of the projection objective. The illumination system has as light source a pulsed laser 115 downstream of which a λ/2 plate 116 that can be rotated about the optical axis of the system is arranged. An optical system 117 placed downstream thereof transmits the light into the angle-conserving, polarization-optimized light mixing device 118, which substantially corresponds to the light mixing device 10 in FIG. 1 with reference to design and function, and is designed for outputting completely s-polarized light. The fully polarized exit light impinges directly on the photomask 112 without interposition of a REMA objective. When it is desired to illuminate the mask with circularly polarized light, a λ/4 plate can be arranged upstream and downstream of the mask, respectively. The light subjected to s-polarization downstream of the mask 112 strikes a polarization splitter layer 117, arranged obliquely in the light path, of a beam splitter block 118 of the projection objective, and is deflected in the direction of the concave mirror 119 of the objective. A λ/4 plate 120 arranged between the beam splitter block and concave mirror ensures that the concave mirror and the upstream lenses are operated with circularly polarized light, while the light retroreflected onto the beam splitter surface 117 is p-polarized, and is thus passed by the layer 117 in the direction of a dioptric objective part, downstream of the beam splitter cube, cube, of the projection objective. Said part can include a deflecting mirror 121 in order to achieve a parallel position of the photomask 112 and wafer 114. An optional λ/2 plate between the beam splitter cube and deflecting mirror can ensure that the mirror 121 is operated with s-polarization, in order to increase the reflectance thereof. A λ/4 plate 122 placed downstream in the direction of the wafer ensures that the wafer and upstream objective lenses are illuminated with circularly polarized light.

When conducting microlithography with pulsed lasers, it is desirable to have good light stability between the individual light pulses of the laser 8, since only a finite number of pulses contribute to exposure during scanning. There are various possibilities for the inverse illumination of the two scanning fields lying one above another. The simplest consists in rotating the polarization of the input light by 90° in each case between individual pulses or pulse groups. As a result, each point in the overall exit surface 11 of the light mixing device has its brightness inverted continuously from pulse to pulse or from pulse group to pulse group in such a way that two assigned pulses or pulse groups produce a time-mean value that represents the mean valve of the output pulses from the laser in a fashion free from any polarization properties. Consequently, when use is made of pulsed lasers a device for rotating the direction of polarization of the light output by the laser, for example a rotatable λ/2 plate 116, is preferably provided between the light source and the integrator rod. Said plate is preferably driven such that during an exposure interval light with different alignments of the preferred direction of polarization enters the light mixing device with approximately equal frequency. Time averaging of various states of polarization at the exit is thereby achieved.

The machine can be operated with very high efficiency for all types of illumination, in particular ring field, quadrupole or dipole illumination. Unrestricted use of photomasks is possible. Owing to the scanning mode (in the y-direction), the illumination of the reticle plane is virtually completely uniform. By driving the rotating λ/2 plate 116 in such a way that approximately identical numbers of pulses with preferred directions of polarization aligned orthogonally to one another are passed during an exposure interval, a uniform illumination of the two outputs of the light mixing device 118 is achieved on average over time. Numerous variants of the system, for example with a REMA objective between the light mixing device and reticle plane, are likewise possible.

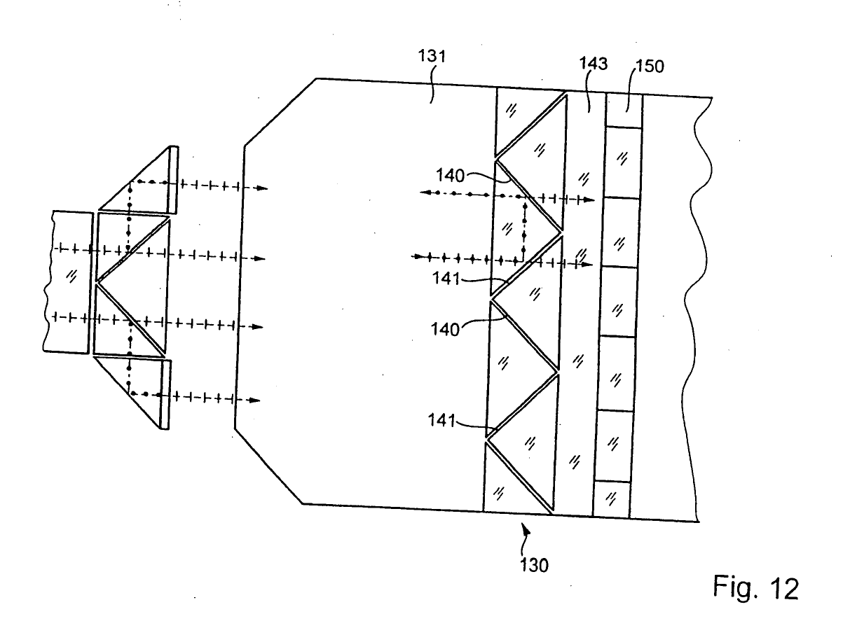

When using imaging optical systems between the light mixing device and reticle, it is to be borne in mind that the state of polarization ideally prepared at the exit of the light mixing device, for example with s- or p-polarization, can still be varied by means of optical components inside the downstream objective, for example by means of intrinsic strain birefringence in the lens material. This problem can be reduced by using a polarization filter 130, explained by way of example with the aid of FIG. 12, which serves here as an intermediate polarizer in order to “refresh” again with p-polarization the state of polarization optimally prepared at the input to the objective 131. The polarization filter has a prism arrangement with at least three, normally substantially more, substantially isosceles prisms that are arranged in an interlocking fashion such that mutually facing perpendicular surfaces of the prisms form a zig-zag arrangement that spreads over the entire cross section of the filter. With reference to their hypotenuses, the prisms are arranged lying next to one another substantially perpendicular to the optical axis. The entire prism arrangement is fastened here on a separate, plane-parallel, transparent carrier 143 that can also, if appropriate, be designed in one piece with the prisms fitted thereon.

A polarization splitter layer is arranged in each case between the perpendicular surfaces lying opposite one another. This produces pairs of polarization splitter layers 140, 141 bordering on one another without a gap, the layers of one pair being inclined in each case, with the inclusion of an angle of approximately 90°, in the direction of the incident light in such a way that light reflected (s-polarized) by a polarization splitter surface of the pair is deflected in the direction of the assigned other polarization splitter surface and is deflected again by the latter into a direction of propagation that runs substantially in an inversely parallel fashion to the direction of incidence of the light. A polarization-selective retroreflector is thereby created which operates (in section) in the manner of a (two-dimensional) cat's eye, passes only light with p-polarization, and completely retroreflects s-polarized light. The form shown has a high efficiency even in the case of substantial angular loading, since no geometric shading takes place.

This principle of intermediate polarization does not impair the uniformity in the reticle, since the intermediate polarizer 130 lies in the region of the pupil of the REMA objective, and thus at a location conjugate to the location of the pupil of the projection objective. The intermediate polarizer can be combined at its output with an optical element 150 for generating a desired output polarization from the light ideally p-polarized downstream of the intermediate polarizer. This can be, for example, a raster plate with a multiplicity of suitably oriented λ/2 facets for producing tangential polarization. Such a component is disclosed, for example, in DE 195 35 392, whose disclosure content is to this extent incorporated in this description by reference.

A polarization filter of the type of the polarization filter 130 can be used in other optical devices independently of the other features of the invention that are described here, in order by means of retroreflection to block components with s-polarization from light which has an arbitrary state of polarization and impinges largely perpendicular to the filter plane, and to pass only p-polarization. An arrangement in the region of small angular loads, for example in the region of a pupil of an objective, is advantageous for a high filter efficiency.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. An illumination system for an optical device comprising:
an optical imaging system arranged between an intermediate field plane and an image plane of the illumination system for imaging the intermediate field plane onto the image plane; and
a polarization filter arranged in the optical imaging system for influencing a state of polarization of light impinging on the polarization filter along a direction running perpendicular to a filter plane, the polarization filter being a polarization-selective filter for transmitting components of one direction of polarization and for blocking components of another direction of polarization.

2. The illumination system as claimed in claim 1, wherein the optical imaging system includes at least one pupil plane that is a Fourier-transform plane relative to the image plane of the illumination system, and
wherein the polarization filter is arranged at or near the pupil plane.
